(19) United States
(12) Patent Application Publication
(10) Pub. No.: US 2013/0079686 A1
(43) Pub. Date: Mar. 28, 2013

(54) APPARATUS, METHODS AND SYSTEMS TO AUGMENT BIPEDAL LOCOMOTION

(71) Applicant: BLAKE SESSIONS, Cambridge, MA (US)

(72) Inventor: BLAKE SESSIONS, Cambridge, MA (US)

(21) Appl. No.: 13/624,475

(22) Filed: Sep. 21, 2012

Related U.S. Application Data
(60) Provisional application No. 61/538,593, filed on Sep. 23, 2011.
(60) Provisional application No. 61/566,352, filed on Dec. 2, 2011.

(51) Int. Cl. A61H 1/02

(52) U.S. Cl. 601/27

(57) ABSTRACT

An apparatus for augmenting bipedal locomotion. The apparatus includes a spring element, a tibia connector coupled to a first end of the spring element, and a foot plate coupled to a second end of the spring element.

### CROSS REFERENCE TO RELATED APPLICATIONS

The present application claims priority to U.S. Provisional Application No. 61/538,593 filed Sep. 23, 2011, entitled “Apparatus, Methods and Systems to Augment Bipedal Locomotion” and U.S. Provisional Application No. 61/566,352, filed Dec. 2, 2011, entitled “Apparatus, Methods and Systems to Augment Bipedal Locomotion,” which applications are incorporated herein by reference in their entireties.

### BACKGROUND

Devices intended to introduce a spring type component into a person's natural locomotion typically fail to provide significant elastic benefit to a user without adding substantial inertial obstacles. Accordingly, such devices are generally characterized by either adding minimal energetic potential or by adding more energetic potential at the cost of substantially increased bulk and cumbersomeness, making such devices less desirable.

Some devices, such as spring loaded jumping stilts, demonstrated for example in U.S. Pat. No. 6,719,671, may have the potential to store and release 1200 J per stilt. However, such devices still suffer from drawbacks, some of which include loss of articulation at the ankle due to constraints by such devices to certain natural movements. An unimpeded person is generally able to balance continuously and naturally by altering the tension in the calf and Achilles tendon, resulting in a change in location of the center of pressure on the sole of the foot (and, correspondingly, on the ground.). Such compensation is necessary given that an upright person is an inherently unstable system. Because spring loaded stilts are a series load type device, the ability to balance via the ankle joint is forfeited. Furthermore, any mechanical work that the calf muscle might otherwise produce during a natural running cycle is substantially negated. As such, a user of spring loaded jumping stilts or other similar devices may find themselves substantially elevated and unable to balance in a natural fashion.

### SUMMARY

In view of the foregoing, various inventive embodiments disclosed herein provide apparatuses, methods, and systems directed to enhancing a wearer's mechanical power without sacrificing control or naturalness of motion. The inventive embodiments disclosed herein augment a user's abilities without imposing significant constraints upon the user's motor control, without attaching large masses to his legs, and without deviating significantly from the user's net body envelope.

Exemplary inventive embodiments disclosed herein provide an apparatus for augmenting bipedal locomotion. The apparatus includes a spring element having a first end and a second end, a tibia connector coupled to the first end of the spring element, and a foot plate coupled to the second end of the spring element. The foot plate forms an angle with respect to an axis extending from the first end of the spring to the second end of the spring. The foot plate is rotatable with respect to the tibia connector such that rotation of the foot plate with respect to the tibia connector in a manner that decreases magnitude of the angle applies a compressive force on the first end and the second end of the spring, thereby biasing the spring.

In some embodiments, the spring element includes a plurality of stacked planar springs slidably coupled together. Each planar spring may include a tapered geometry increasing in width from the first end to the second end. In various embodiments, each planar spring may include a plurality of distinct tapered sections. The plurality of stacked planar springs may include a plurality of supporting plates interleaved between springs in accordance with various embodiments. The supporting plates may include a curved edge having a decreasing radius of curvature.

In various embodiments the apparatus includes a clutch coupling the foot plate to the second end of the spring element. The clutch is configured to engage and disengage the spring element from the footplate and may be configured for engagement through positive friction. The apparatus of claim 7, wherein the clutch is configured for engagement through positive friction. The clutch may include an actuation cable in accordance with exemplary embodiments. The actuation cable may be activated by pivoting the foot plate.

In some embodiments, the foot plate includes a truss structure. In some embodiments, the foot plate includes a coupling strap. In some embodiments, the foot plate includes a shoe. In some embodiments

The tibia connector may include a distributor in accordance with various embodiments.

In some embodiments, the spring element may include a composite material.

It should be appreciated that all combinations of the foregoing concepts and additional concepts discussed in greater detail below (provided such concepts are not mutually inconsistent) are contemplated as being part of the inventive subject matter disclosed herein

### BRIEF DESCRIPTION OF THE DRAWINGS

It should be appreciated that the figures, described herein, are for illustration purposes only, and that the drawings are not intended to limit the scope of the disclosed teachings in any way. In some instances, various aspects or features may be shown exaggerated or enlarged to facilitate an understanding of the inventive concepts disclosed herein (the drawings are not necessarily to scale, emphasis instead being placed upon illustrating the principles of the teachings). In the drawings, like reference characters generally refer to like features, functionally similar and/or structurally similar elements throughout the various figures.

FIG. 1 shows the entirety of a bipedal locomotion augmenting device, wearable about the tibia shinbone and ankle in accordance with various inventive embodiments.

FIG. 2 shows the spring assembly portion of the device illustrated in FIG. 1.

FIGS. 3A and 3B show a side view of the spring assembly portion of FIG. 1 in unloaded and loaded states respectively.

FIG. 4 shows the body interfacing portions of the device illustrated in FIG. 1.

FIG. 5 shows the deformation kinematic of the device depicted in FIG. 1.

FIG. 6 shows a perspective view of a wearable device, in accordance with various inventive embodiments.

FIG. 7 illustrates a side view of the device show in FIG. 6.

FIGS. 8-10 illustrate deformation kinematics of the device of FIG. 6 transitioning from an un-flexed state to a flexed state.

FIG. 11 shows a side view of a wearable device including a clutch mechanism in accordance with various inventive embodiments.

FIGS. 12 and 13 shows rear perspective views of the device shown in FIG. 11.

FIG. 14 shows a rear view of the device shown in FIG. 11.

FIG. 15 shows a top view of the device shown in FIG. 11.

FIG. 16 shows a side view of the device shown in FIG. 11 with the clutch engaged and further including an exemplary actuator.

FIG. 17 provides a side view of a spring system in accordance with various inventive embodiments.

FIG. 18 provides a front view of one of the spring shown in FIG. 17.

FIG. 19 depicts a magnified side view of the spring system shown in FIG. 17.

### DETAILED DESCRIPTION

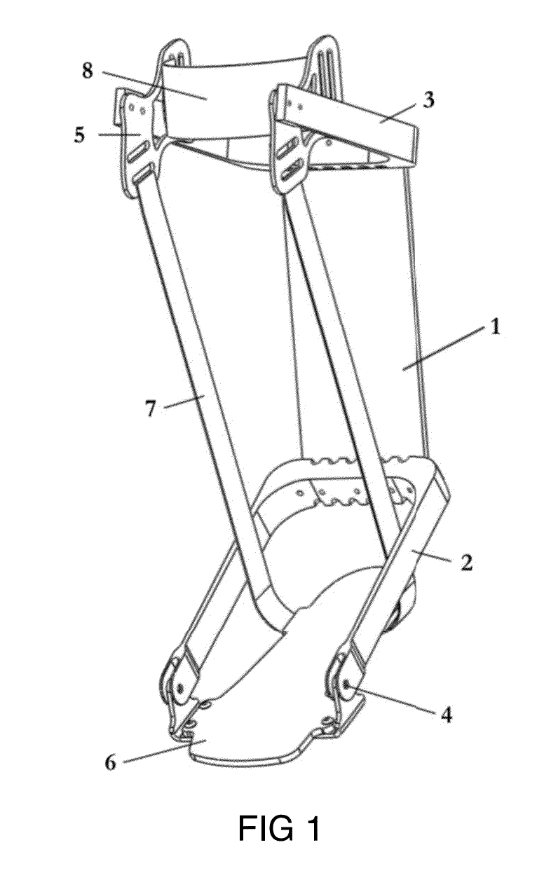

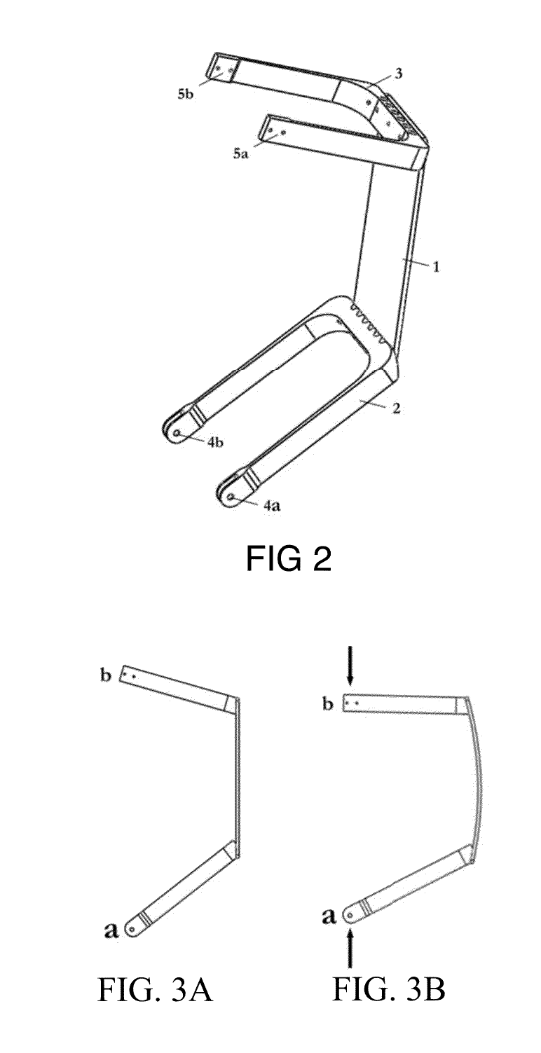

One innovative feature of various inventive embodiments is the offset bow-spring construction, depicted in FIG. 2. In the embodiments illustrated in FIGS. 1-5, the bow spring consists of a flat flexible plate of material 1 fixed by its ends to two U-shaped spring mounts, 2 and 3. Positive spatial derivative curvature surfaces reside in the spring mounts under each fastening point in order to minimize stress concentrations at each fastening location. Each spring mount is angled away from the flexible spring material in order to best coincide with body geometry. Load points 4a and 4b exist on the lower spring mount, with pinned holes. Load areas 5a and 5b exist on the upper spring mount, with threaded holes for fastening to the strap mounts 5 (shown in FIG. 1).

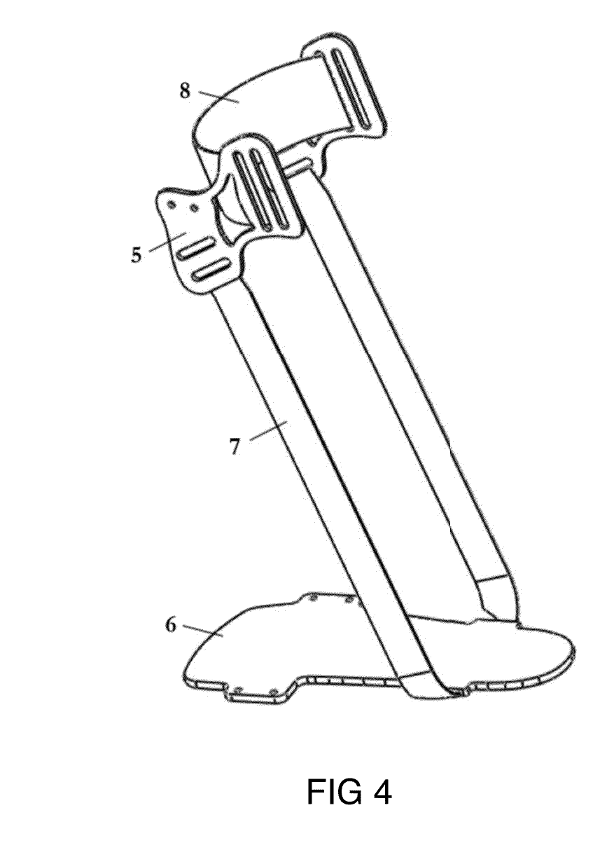

A side view of the offset bow-spring in both unloaded and loaded states is depicted in FIG. 3. The spring assembly is loaded in two force compression from point a to point b (a total of four load points). The resulting load causes flexion of the spring material, which results in angular displacement of the spring arms and a net linear displacement from point a to point b. Because no torques are applied at either location, the spring may be modeled as a net compliant two-force compression spring, providing a stiffness K˜12 kN/m between points a and b.

An important aspect of this implementation is that the spring material is placed at an approximately constant distance from the 2FM compression axis, resulting in nearly uniform curvature throughout the length of the spring. This substantially constant curvature yields a highly efficient and energetic utilization of the material. This is in stark contrast to most bow-spring designs, in which the resultant curvatures are non-constant as a function of location and the material is used ineffectively.

The following relationship applies to any constant cross section leaf-type spring undergoing bending. Using s as a variable for path length along the spring and K(s) as the curvature along the path, the geometric load condition efficiency G is as follows:

$$Gf = \frac{{\int }_{0}^{L} {K ( s )}^{2}}{K {max}^{2} \cdot L}$$

Where Gf is the efficiency factor and Kmax is the maximum curvature at any point in the spring. This integral is maximized and is equal to 1 when K(s)=constant, which, for a two-force member spring, is when the entirety of the spring material resides at a constant offset distance from the compression axis, as previously described. This is differentiated from most constant-cross section bow-spring designs, in which Gf may be as low as 0.2. The spring being utilized in this circumstance stores an unprecedentedly high amount of energy as compared to its mass.

The implementation of the spring is such that it spans the ankle joint. The desired behavior is, when the ankle dorsiflexes from its fully plantar-flexed state during initial stance, the spring absorbs a portion of the energy and seeks to return the foot to full plantarflexion during terminal stance. In order to provide this parallel impedance to the ankle, the spring must be fastened between the foot and tibial frames.

Referencing FIG. 1, compatibility with the foot is maintained by the joints 4a and 4b that are pinned to the footplate 6, which is secured to the foot. The upper spring mount has load areas at 5a and 5b, which are fastened to the strap plates 5. These strap plates serve to connect the spring to straps that provide the appropriate loading responses necessary to maintain the compatibility between the upper end of the spring and the tibial frame. In FIG. 4, a strap 7 connects to the strap plates 5, runs down both sides of the leg and underneath the foot plate 6. This arrangement assists in counteracting the major component of the compressive spring action. The lower end of the strap is located approximately underneath the ankle joint, so as to minimize the net torque to the ankle joint when it bears tension. The foot plate 6 serves primarily to distribute the tensile load of the strap evenly across the sole of the foot. Near the shin area, the shin strap 8 is connected to the strap mounts 5 and helps counteract the component of the spring load that is transverse to axis of the tibia.

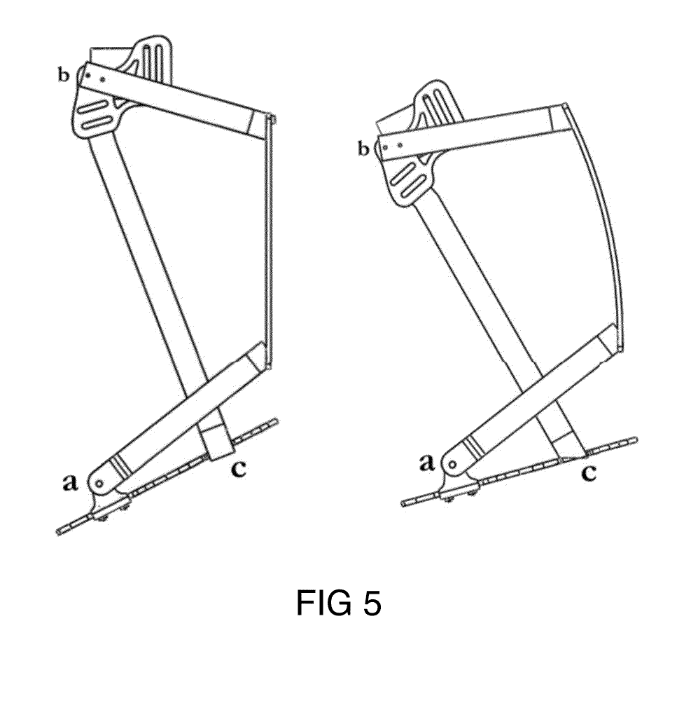

Resultant behavior of the device can be seen in FIG. 5. The left-hand frame shows the unbiased system and the right-hand frame shows the deflected system, both in a fixed (ground) frame of reference. During initial stance, as a toe runner's ankle flexes and his center of mass lowers, his foot presses on the footplate 6, which is displaced downward. The stiff and nearly vertical strap 7 ensures that the top ends of the spring displace downward, via load areas 5a and 5b, with the tibial frame. The spring is compressed between the upper ends, at load areas 5a and 5b, which travel downward, and the lower ends, at joints 4a and 4b, which essentially reside on the ground in the fixed frame. The reverse behavior ensues during terminal stance, in which the energy is released as the foot plate and the person are catapulted upward by the spring.

Various inventive embodiments may include one or more user control elements that help to enhance mobility by limiting constraints on motion that might occur due to natural tendency of springs to return to an unbiased or uncompressed state. An exemplary inventive embodiment of such an element comprises a clutch that allows a user to engage and disengage the spring, for example by forces transmitted via the foot (or a portion thereof), and resultantly controls the time at which the additional elasticity of the spring is imparted. In various embodiments, the clutch may be controlled by the user employing a heel strike. For example, in some embodiments when a user applies force on the heel, the clutch disengages the spring and substantially natural motions (i.e. deviating only slightly, if at all, from natural kinematics) will ensue. Should the user instead employ a toe-strike, the elastic element will be re-engaged.

In some embodiments where the heel strike controls disengagement of the clutch, the clutch may maintain engagement of the spring until the heel strike is applied and after the heel strike is released the clutch may automatically re-engage the spring. As noted above, in some embodiments the clutch may be controlled by force imparted by a frontal part of the foot (for example the ball or the toes). In embodiments where the toe strike controls engagement of the clutch, the clutch may maintain disengagement of the spring until the toe strike is applied, at which point the spring would become engaged, and after the toe strike is released (when substantially no force is any longer placed on the toe) the clutch may automatically re-disengage the spring. Accordingly, inventive embodiments comprising a clutch element afford increased flexibility and allow increased levels of substantially unimpeded dorsiflexion and plantarflexion of the ankle during swing phase.

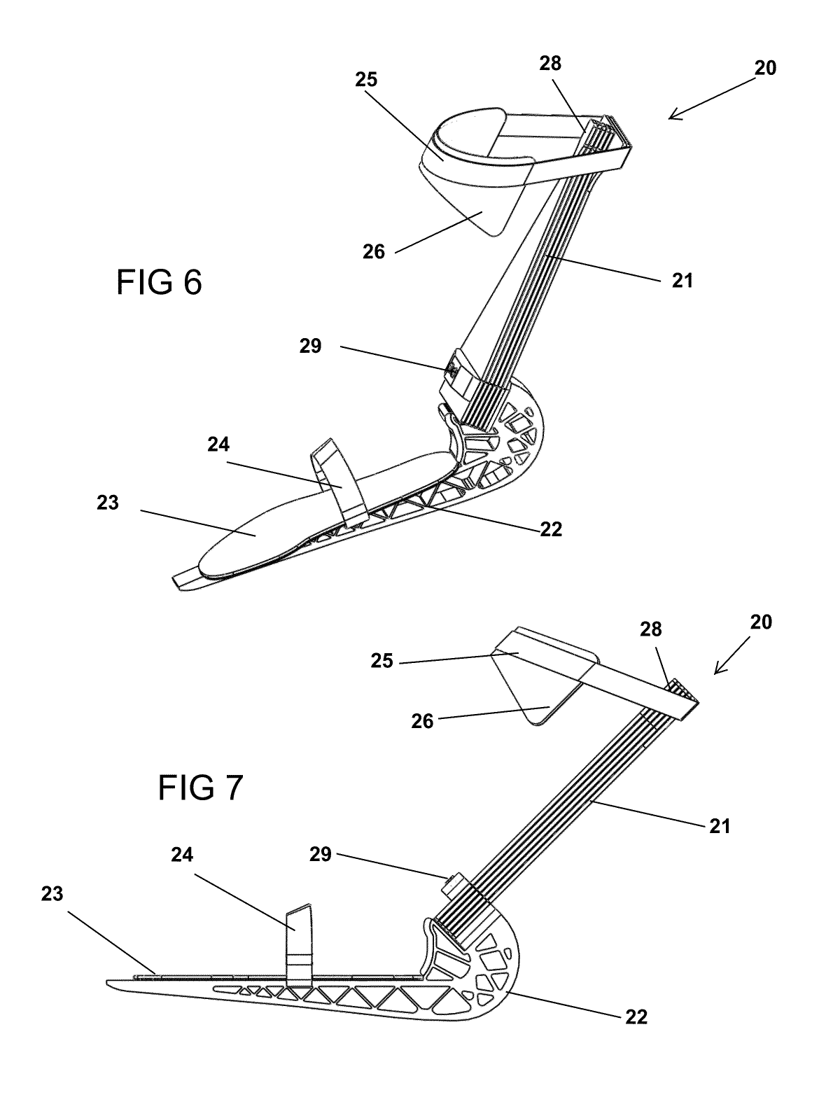

FIGS. 6 and 7 depict another inventive embodiment of a device configured to augment bipedal locomotion. The embodiment illustrated in FIGS. 6 and 7 includes a device 20 that spans the ankle joint by connecting to both the foot and the tibial frame, and provides a net torsional impedance between them. The majority of the structure (including the footplate 23 and the truss structure 22, residing underneath foot plate 23) remains firmly strapped to the foot via strap 24 and deviates only slightly from the frame of the human foot itself. The plurality of triangular-shaped springs 21 extend from connection 29 of truss structure 22 up the leg to anchor behind the shin. At the loading end of the springs is a strap mechanism 25 linked to a distributor 26 configured for positioning at the front of the tibia shinbone. Strap 25 allows flexured vertical motion while constraining the transverse position of the load point 28 with respect to the tibial frame. As a person's ankle flexes, the springs deflect as shown in

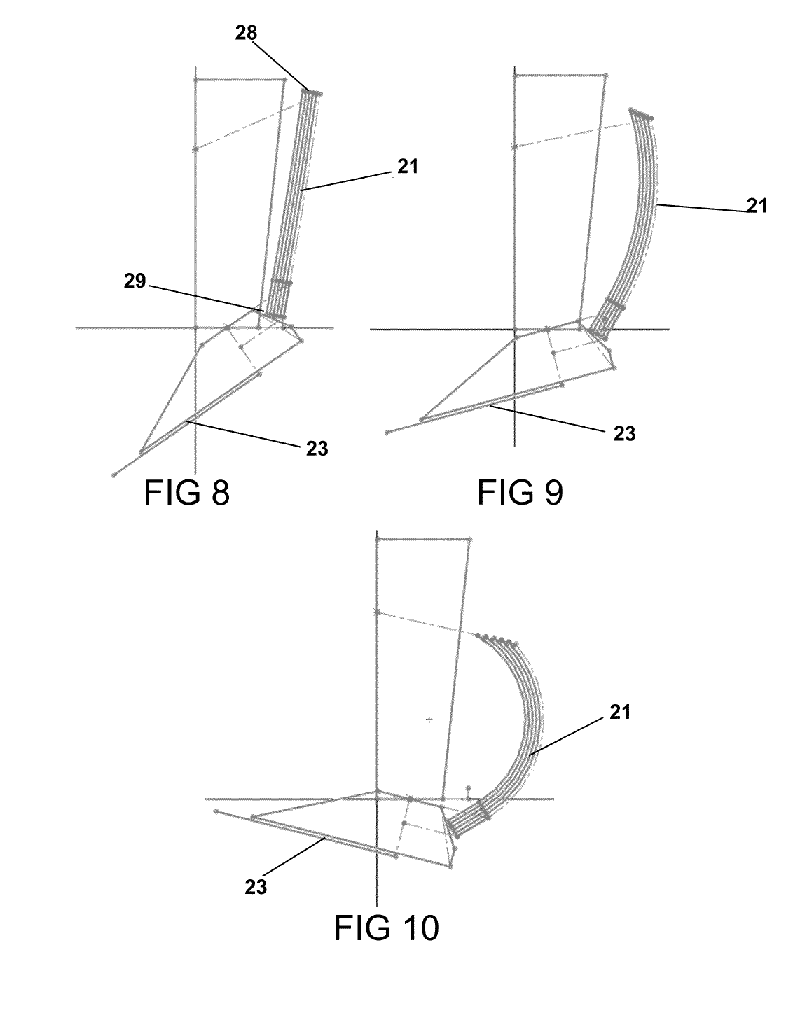

FIGS. 8-10 depict motion of the bipedal locomotion augmenting device and the change in spring bias through ankle flexing. FIG. 8 shows a schematic of device 20 with spring element 21 in an unbiased state and with footplate 23 forming an obtuse angle with respect to an axis extending through ends 28 and 29 of the spring element. FIG. 9 shows what happens to device 20 when a user wearing device 20 flexes his or her ankle As shown in FIG. 9, the rotation exhibited by foot plate 23 as device 20 transitions from the state shown in FIG. 8 to that of FIG. 9 generates compressive forces on spring element 21, thereby biasing the spring. FIG. 10 shows further biasing of spring element 21 in response to further rotation or flex of foot plate 23 (vis-à-vis rotating the ankle with respect to the tibia frame). Each spring of spring element 21 may be approximately triangularly shaped or tapered to increase energetic utilization of the material in various inventive embodiments. The springs may also include Teflon™ plain bearings positioned between them at the upper loading point 28, which bearings allow relative sliding of the springs in a manner similar to leaves of paper shearing with respect to one another in a book as the book is bent. Multiple springs may be stacked in order to provide a desired level of stiffness and energy in the kinematic. Additionally, the ability to easily vary the springs provided by such embodiments has the added benefit of provided a device that may be easily tailored to a discrete level of stiffness desired by a specific user.

Other inventive aspects include embodiments where one or more additional degrees of freedom are provided in the foot plate to allow toe flexure and embodiments where the foot plate only spans a lengthwise portion of the foot to similarly provide an additional degree of freedom in the foot. In embodiments providing one or more additional degrees of freedom via flexibility in the foot plate, a clutch may be built into and activated by flexure of the toe during a toe strike (i.e. the user standing essentially on the ball of the foot). Flexing of the toe, in such embodiments may cause the clutch to engage the spring or elastic element according to the protocols described herein. Similarly, a return to the un-flexed state of a flexible foot plate may cause the clutching element to disengage the spring or elastic element so that a natural stance may be resumed by a user.

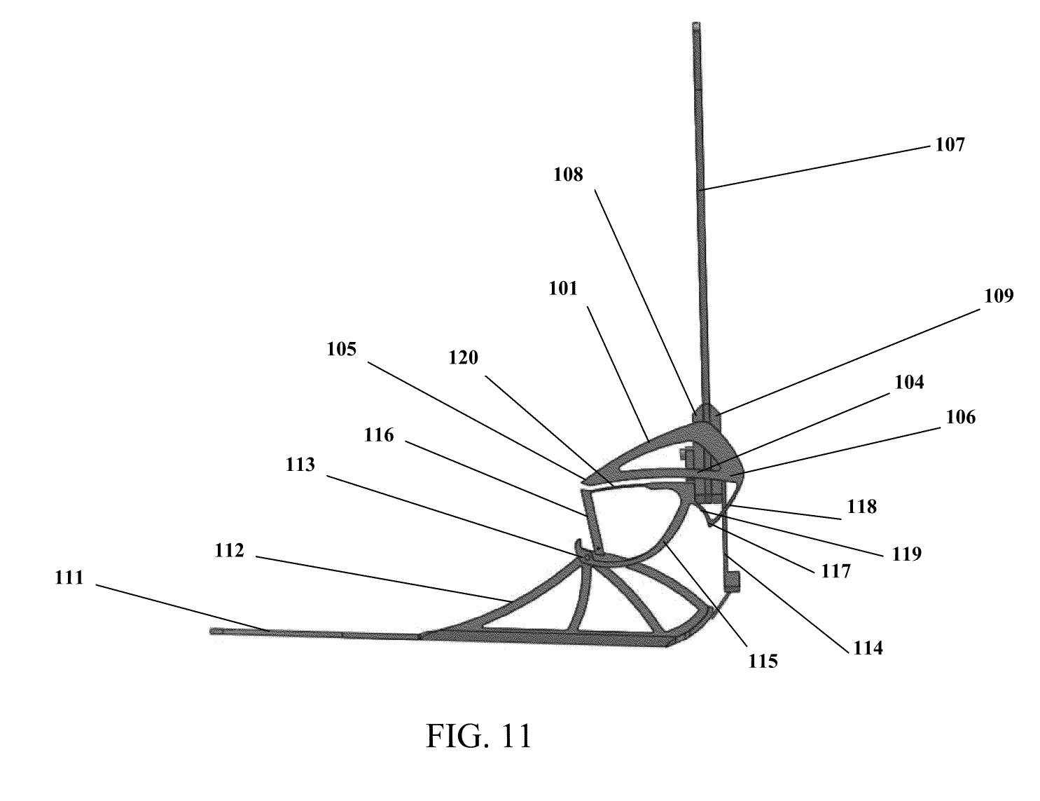

FIG. 11 shows a side view of a wearable device including a clutch mechanism, in accordance with various inventive embodiments. The clutch mechanism is provided in various embodiments to afford the aforementioned additional degrees of freedom about the ankle joint. Accordingly, the function of the clutch mechanism is to allow selective engagement and disengagement of one of the spring systems provided according to various inventive embodiments. With a clutched system, the user is able to move their joint (ankle or knee) at will during a swing phase (for example when the foot is not in contact with the ground.). This additional level of mobility allows substantially unimpeded knee flexion during swing, and also dorsiflexion of the ankle. In the embodiment depicted in FIG. 11, the clutching mechanism operates on the principle of engagement through positive friction. The clutching mechanism includes a clutch actuator that may reside at the toe of the device, thereby allowing substantially unimpeded heel-strike gaits to be achieved. Once a user presses forward on the actuator via the toe (for example when jumping), the system will engage and support the user elastically.

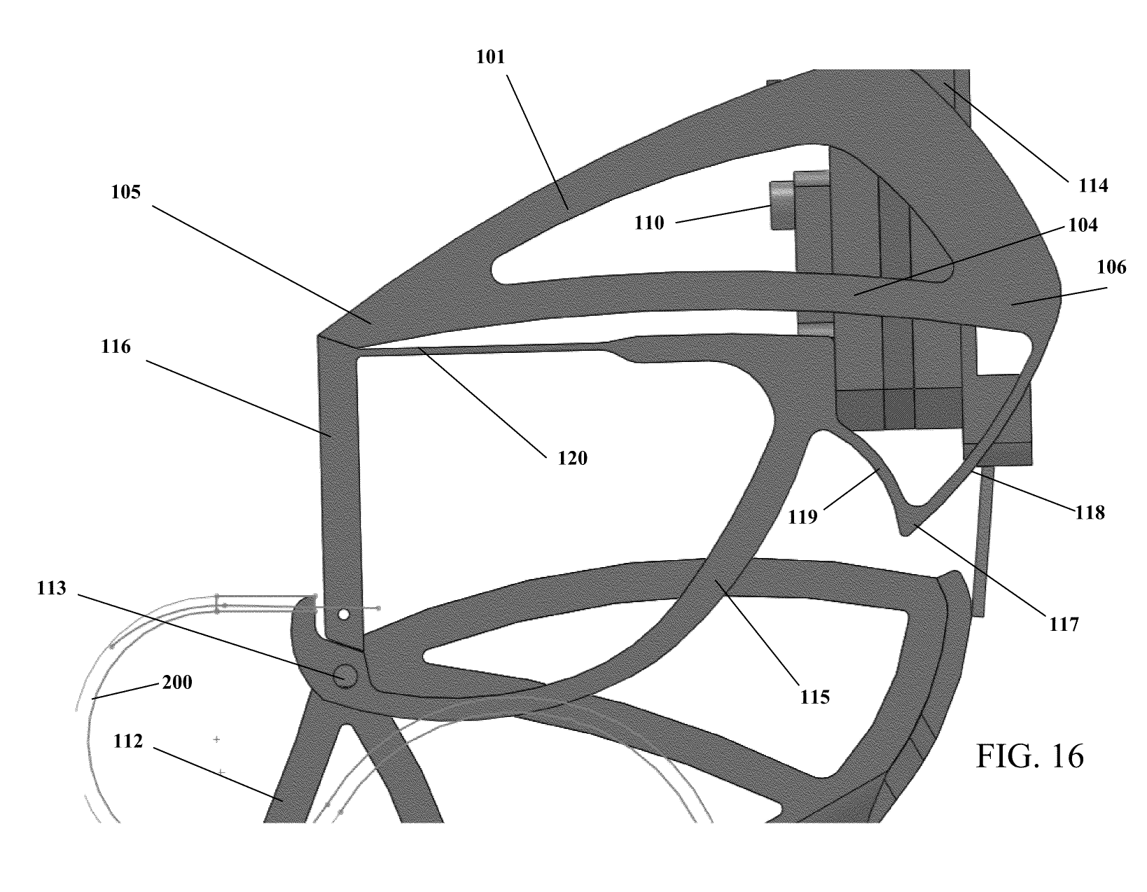

As depicted in FIG. 11, upper bind arm 101 of the clutching mechanism is pivotally coupled to the base of spring 107 via bolt 104. A lower bind arm 115 is connected to upper bind arm 101 via arm 118 of v-shaped flexure 117. V-shaped flexure 117 permits horizontal motion and rotation of upper bind arm 101. Lower bind arm 115 is pivotally coupled to base truss 112 of base plate 111. In the disengaged configuration, the components of the clutch allow base plate 111 to rotate with respect to spring 107 so that a user has substantially unimpeded ankle flexion. In the disengaged configuration, base plate 111 is able to pivot at pivot point 113, which pivotal motion allows tongue 114, which extends from base plate 111, to slide between outer bind arm 103 and spring base plate 109 on the surface of plate 109 in an upward direction (in the depicted configuration). Upon engagement of the clutching mechanism (through exemplary actuators discussed further herein), engagement pillar 116 shifts forward and upward (as further depicted in FIG. 16), which movement elastically extends disengagement flexure 120, such that pillar 116 provides a rigid path between lower bind arm 115 and upper bind arm 101. This rigid pathway allows forces transmitted through lower bind arm (for example by a user) to be transmitted through inner tip 105 of bind arm 101 in a manner that causes bind arm 101 to rotate and generate forces at inner bind arm crossbar 102 and outer bind arm crossbar 103. Furthermore, because v-shaped flexure 115 provides a force pathway that is much more compliant than the pathway provided by pillar 116, a substantially larger portion of a force transmitted by a user through lower bind arm 115 will be transmitted through engagement pillar 116 than through v-shaped flexure 115, thereby providing the desired clockwise rotation of upper bind arm 101 about bolt 104. The forces generated at each of the crossbars 102 and 103, as a result of the rotation of upper bind arm 101, are transmitted laterally inward towards the spring positioned between crossbars 102 and 103. The lateral force generated at crossbar 103 presses tongue 114 against spring base plate 109, such that elevated frictional forces between tongue 114 and spring base plate 109 as well as elevated frictional forces between tongue 114 and crossbar 103 prevent tongue 114 from sliding, thereby preventing rotation of lower base plate 111. The fixed orientation of base plate 111 and associated base truss 112 due to the binding of tongue 114 and the binding of upper bind arm 101 permit forces transmitted by the user through base plate 111 to be transmitted through the rigid connection between the lower bind arm 115 and upper bind arm 101 to the base of spring 107, such that the force transmitted by the user causes deformation of spring 107 in a manner similar to that provided by the embodiment depicted in FIGS. 6 and 7 where the base is depicted as fixed with respect to the spring and is kinematically demonstrated in FIGS. 8-10.

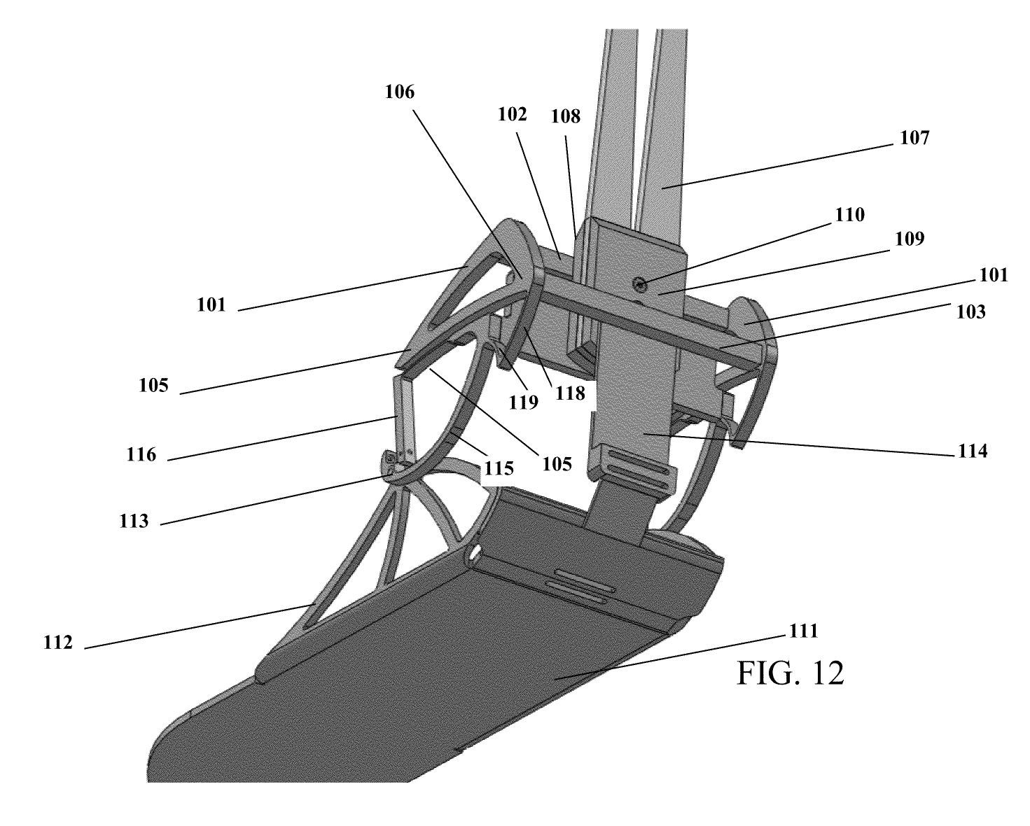

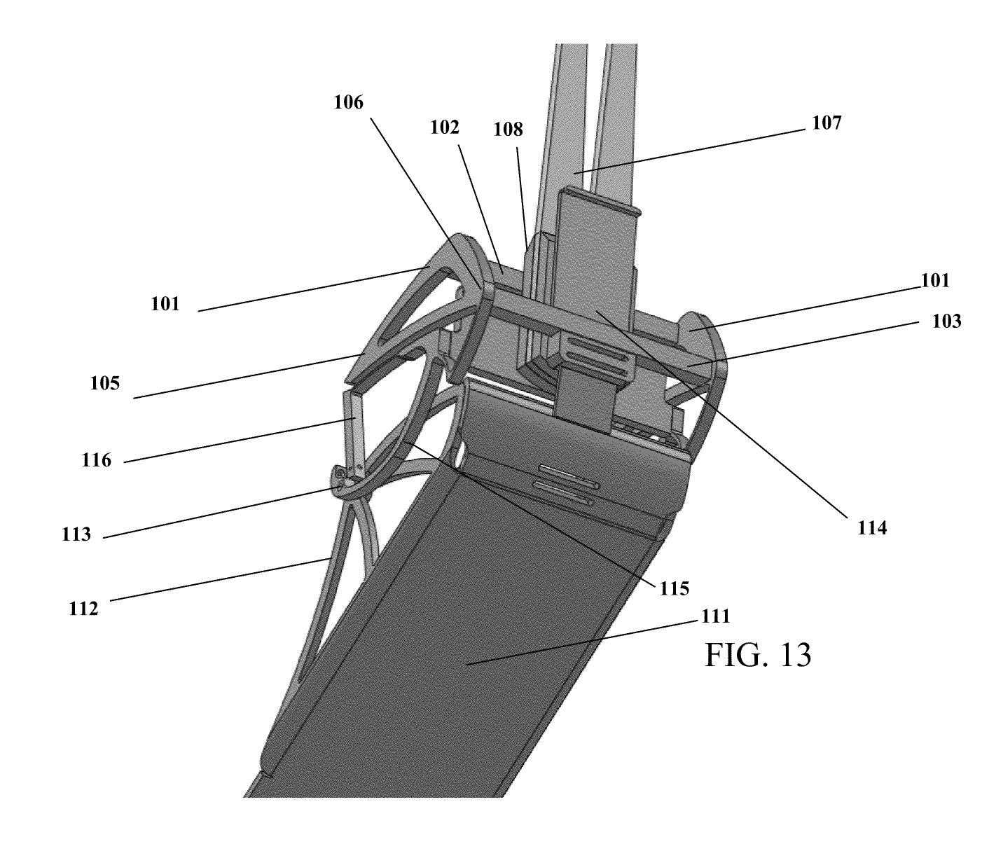

FIGS. 12 and 13 show rear perspective views of the device shown in FIG. 11. FIGS. 12 and 13 show a range of motion of tongue 114 permitted when the clutching mechanism is disengaged (i.e. when the disengagement flexure 120 is in a relaxed or un extended configuration and engagement pillar 116 thereby does not provide a rigid connection between lower bind arm 115 and upper bind arm). Specifically, in FIG. 12, a distal end of tongue 114 is near the base of the spring 107 and crossbar 103. As such, FIG. 12 is representative of the device engaged with a foot in a neutral position or in a position where the foot forms an acute angle with respect to the tibia. In FIG. 13, a proximal end of tongue 114 is near the base of spring 107 and crossbar 103 As such, FIG. 13 is representative of the foot in an extended configuration where the foot forms an obtuse angle with respect to the tibia.

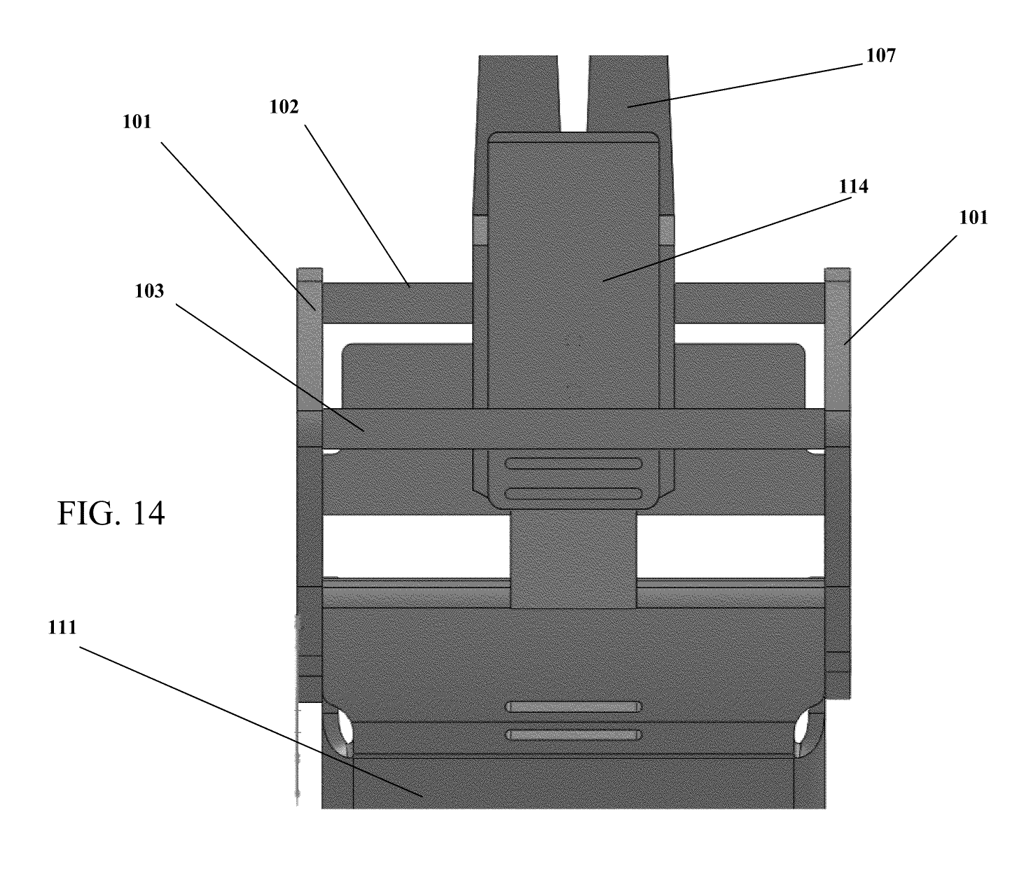

FIG. 14 shows a rear view of the device shown in FIG. 11. In FIG. 14, the device of FIG. 11 is configured in the unengaged and flexed configuration, as provided in FIG. 13, such that a proximal end of tongue 114 is near the base of spring 107 and crossbar 103. FIG. 14 is again representative of the foot in an extended configuration where the foot forms an obtuse angle with respect to the tibia.

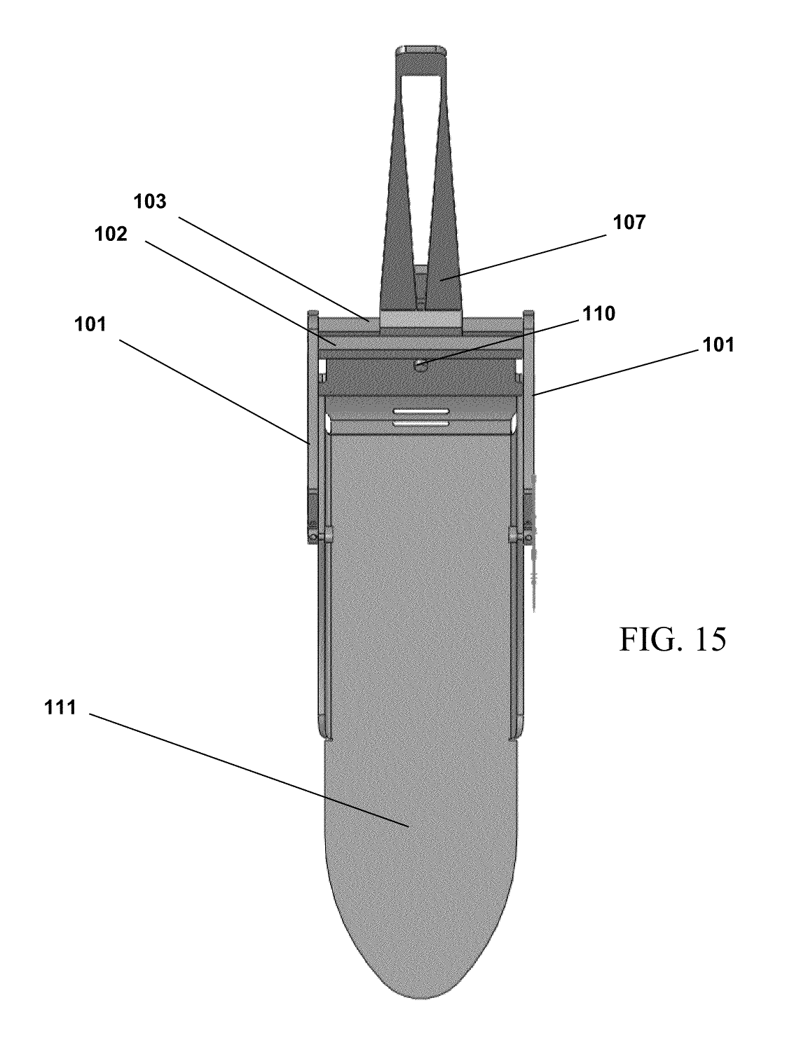

FIG. 15 shows a top view of the device shown in FIG. 11. In FIG. 15, each of the upper bind arms 111 are shown on opposing sides of base plate 111. Additionally, bolt 110 is visible in the orientation provided in FIG. 15. Bolt 110 further permits rotation about an axis traveling through the bolt allowing a user to have full medial and lateral roll capability of the ankle to allow controlled cornering.

FIG. 16 shows a side view of the device shown in FIG. 11 with the clutch engaged and further includes an exemplary actuator, Bowden cable 200. Cable 200 may extend from engagement pillar 116 to an actuating lever positioned beneath base plate 111. The lever may be actuatable via a toe strike, which strike may cause pillar 116 to move forward and upward when pulled by the cable and thereby positions pillar 116 such that it provides a rigid pathway between upper bind arm 101 and lower bind arm 115. Cable 200 may be biased such that when not engaged it ceases to exert a forward or pulling force on pillar 116. When such a forward force is not exerted on pillar 116, disengagement flexure 120 will return to the relaxed configuration, thereby disengaging pillar 116 from direct contact with upper bind arm 101.

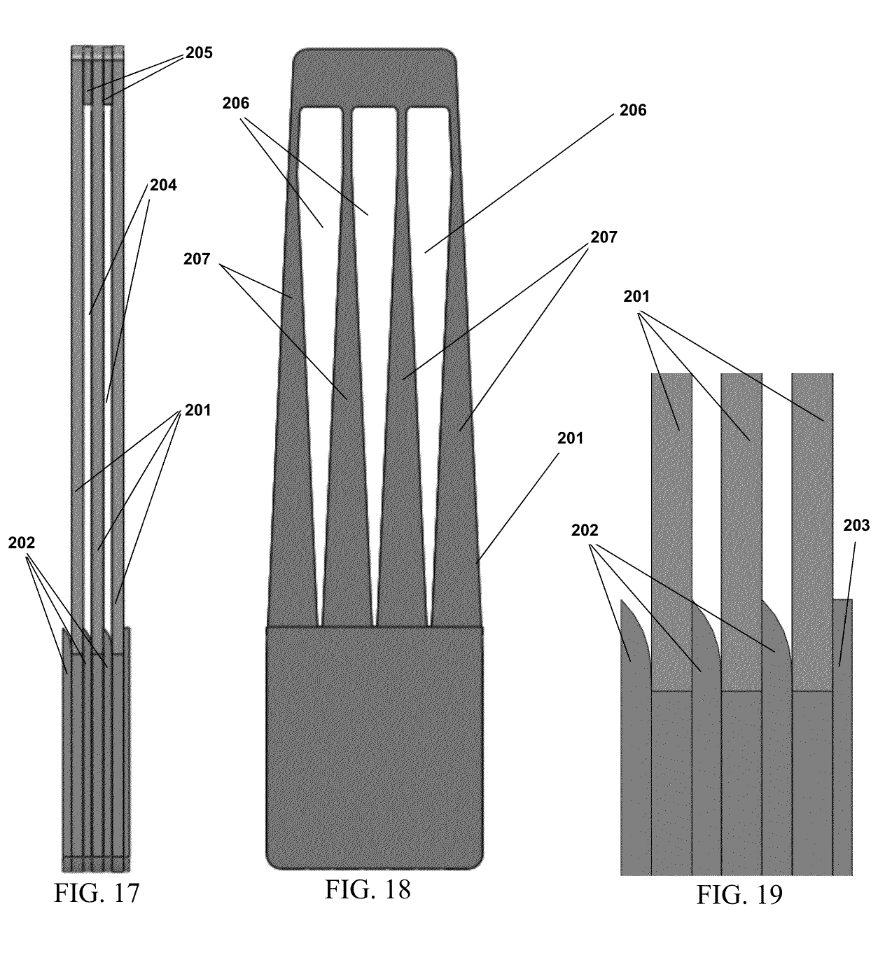

FIG. 17 is a side view of a spring in accordance with various inventive embodiments. Spring 201 spans the ankle joint by connecting to both the foot and tibial frames and providing a net torsional impedance between them. In use, the springs may include a strap mechanism as depicted in other embodiments, which may be coupled to a distributing plate for positioning at the front of the shin. Such a strap allows flexured vertical motion while constraining the transverse position of the load point with respect to the tibial frame. Accordingly, as a user's ankle flexes, the springs deflect in bending as depicted in FIGS. 8-10. As depicted in FIG. 17, various inventive embodiments may include a plurality of springs 201 stacked to provide the stiffness and energy desired in the kinematic. The stacked configuration also allows ease in modulating the overall stiffness of the device through addition or removal of springs. In the stacked configuration, Teflon plain bearings 205 may be provided at the upper loading point to allow relative sliding of the springs, in a manner similar to leaves of paper shearing in a book as the book is bent. Support plates 202 may be provided at the base of stacked springs 201 to provide a reaction force and a reaction moment to the input in a cantilevered style. Support plates 202 may be provided with an end having a decreasing radius of curvature (as opposed to a constant radius of curvature or a squared edge). In an implementation where a spring is flexed against a squared supporting plate, a large stress concentration resides at the contact point of the plate and the flexed spring. Smoothly transitioning geometries between the spring and supporting plate results in a lower stress gradient. Accordingly, plates 202 are provided with a decreasing radius of curvature (decreasing towards the tip of plates 202) to distribute contact stresses in the spring. Specifically, the curve of the supporting plates 202 has a positive derivative at all locations, resulting in a first-order representation in an exemplary embodiment (higher order functions may be implemented). The net Cartesian representation of this particular curve is cubic. The result of this implementation is that as flexion of spring 201 becomes greater, the curve engages more of the surface of plate 202 in rolling contact towards the end, with a comfortably distributed contact stress that reduces the likelihood of causing fracture upon greater deflections. An implementation of supporting plates 202 and bearings 205 may permit spacing 204 between springs 201 when the springs are in an unloaded or unstrained state.

FIG. 18 is a front view of the spring shown in FIG. 17. Springs 201 are tapered to have a narrower width near an upper portion of the spring and thereby maximize the energetic utilization of the material. Furthermore, as demonstrated in FIG. 18, each spring may consist of a plurality of distinct tapered sections 207 coupled together at the top whereby voids 206 are disposed there between. The use of multiple sections assists in the minimization of the taper angle of spring 201, which reduces the likelihood of fracture due to the imposition of high epoxy shear stresses. This arrangement of materials allows for a highly effective bending stiffness with reduced material usage and provides linearly decreasing bending stiffness, which results in a highly efficient use of material.

FIG. 19 is a magnified side view of the spring shown in FIG. 17. The decreasing radius of curvature of bearings 202 may be more readily seen in the magnified view provided by FIG. 17. Additionally, as demonstrated the spring stack may be bounded by a spring base plate 203, which plate may be provided on one or both sides of the base of the spring stack.

Various inventive concepts provided herein may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The above described embodiments of the present invention provide solely exemplary embodiments. Those of ordinary skill in the art will appreciate that the present invention includes variations and modifications of the disclosed embodiments are within the scope of the present invention and may be captured by any claims provided herein or added hereto.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of and “consisting essentially of shall be closed or semi-closed transitional phrases, respectively, as set forth in the United States Patent Office Manual of Patent Examining Procedures, Section 2111.03.

1. An apparatus for augmenting bipedal locomotion, the apparatus comprising:
a spring element having a first end and a second end;
a tibia connector coupled to the first end of the spring element; and
a foot plate coupled to the second end of the spring element, the foot plate forming an angle with respect to an axis extending from the first end of the spring to the second end of the spring, the foot plate rotatable with respect to the tibia connector such that rotation of the foot plate with respect to the tibia connector in a manner that decreases magnitude of the angle applies a compressive force on the first end and the second end of the spring, thereby biasing the spring.

2. The apparatus of claim 1, wherein the spring element includes a plurality of stacked planar springs slidably coupled together.

3. The apparatus of claim 2, wherein each planar spring has a tapered geometry increasing in width from the first end to the second end.

4. The apparatus of claim 2, wherein each planar spring has a plurality of distinct tapered sections.

5. The apparatus of claim 2, wherein the plurality of stacked planar springs include a plurality of supporting plates interleaved between springs.

6. The apparatus of claim 5, wherein the supporting plates include a curved edge having a decreasing radius of curvature.

7. The apparatus of claim 1, further comprising a clutch coupling the foot plate to the second end of the spring element, the clutch configured to engage and disengage the spring element from the footplate.

8. The apparatus of claim 7, wherein the clutch is configured for engagement through positive friction.

9. The apparatus of claim 7, wherein the clutch includes an actuation cable.

10. The apparatus of claim 9, wherein the actuation cable is activated by pivoting the foot plate.

11. The apparatus of claim 1, wherein the foot plate includes a truss structure.

12. The apparatus of claim 1, wherein the foot plate includes a coupling strap.

13. The apparatus of claim 1, wherein the foot plate includes a shoe.

14. The apparatus of claim 1, wherein the foot plate includes a distributor.

15. The apparatus of claim 1, wherein the spring element includes a composite material.
